(19) United States
(12) Patent Application Publication
(10) Pub. No.: US 2026/0025071 A1
(43) Pub. Date: Jan. 22, 2026

(54) CIRCUIT AND METHOD FOR CONTROLLING SWITCHING REGULATOR

(71) Applicant: Renesas Design (UK) Limited, Bourne End (GB)

(72) Inventor: Dashun XUE, Germering (DE)

(73) Assignee: Renesas Design (UK) Limited, Bourne End (GB)

(21) Appl. No.: 18/774,063

(22) Filed: Jul. 16, 2024

(51) Int. Cl. H02M 3/158

(52) U.S. Cl. CPC H02M 3/158

(57) ABSTRACT

A switching regulator is provided. The switching regulator generates an output voltage based on an input voltage using at least one power switch and an inductor. The switching regulator includes a first control circuit for generating a first control signal for turning off the power switch, in dependence of a level of the inductor current through the inductor. The switching regulator further includes a second control circuit for generating, based on a reference clock signal for setting a switching frequency of the switching regulator, a second control signal for turning on the power switch, in dependence of the level of the inductor current through the inductor. The switching regulator further includes a frequency locking circuit coupled to the second control circuit and for generating a periodic threshold signal based on the reference clock signal to control the generation of the second control signal.

### TECHNICAL FIELD

The present document relates to switching regulators. In particular, the present document relates to circuits and methods for controlling a switching regulator (such as a DC-DC converter and/or a Buck, Boost, or Buck/Boost converter).

### BACKGROUND

A common method of controlling a switching regulator is hysteretic control. The power switches of a switching regulator are controlled by the output signals of two comparators that monitor the peak and valley values of the inductor current and that can be called “peak comparator” and “valley comparator”, respectively. One drawback of hysteretic control is that the switching frequency of the switching regulator is not constant in pulse-width modulation (PWM) mode (e.g., in a continuous conduction mode, CCM, under heavy load condition). Besides, the switching frequency may vary depending on temperature, input/output voltage, etc.

When constant switching frequency is required in some application scenarios, one method to achieve this is to apply a frequency lock loop (FLL) to adjust switching frequency of a switching regulator and to reduce drift of the switching frequency. Specifically, a FLL may be implemented in digital domain to generate a hysteresis window for the two comparators. When the switching frequency is off (departing from) a target value, the FLL will adjust the hysteresis window to force the switching frequency back to the target value.

There are two main issues in hysteretic control with a FLL. One is that frequency accuracy of the switching regulator can be affected by noise in the circuit which could be the noise of the devices or the noise coupled to the control loop from other nets such as from input or ground. A second issue is that the frequency locking speed may be too slow.

Accordingly, the present document is directed at the technical problem of providing a fast and accurate control scheme for a switching regulator.

### SUMMARY

According to an aspect, a switching regulator is described, which is configured to generate an output voltage based on an input voltage using at least one power switch and an inductor. The switching regulator comprises a first control circuit which is configured to generate a first control signal for (repeatedly) turning off the power switch, wherein the first control signals is generated in dependence of the level of the inductor current through the inductor. Furthermore, the switching regulator comprises a second control circuit configured to generate a second control signal for (repeatedly) turning on the power switch, wherein the second control signal is generated based on a reference clock signal for setting a switching frequency of the switching regulator and in dependence of the level of the inductor current through the inductor.

In addition, the switching regulator also comprises a frequency locking circuit which is coupled to the second control circuit. The frequency locking circuit is configured to generate a periodic threshold signal based on the reference clock signal to control the generation of the second control signal. In particular, the periodic threshold signal may be synchronized with the reference clock signal, and each period of the periodic threshold signal may comprise a target waveform having at least two distinct signal portions.

Accordingly, the proposed frequency control/locking scheme according to the present document allows for controlling a (voltage) switching regulator in a stable and accurate manner, such that the switching frequency of the switching regulator can be locked to a target value with an improved locking speed (i.e., a relatively fast/short reaction time) subject to noise present in the circuit of the switching regulator. Thereby, better frequency accuracy and faster frequency locking speed can be achieved in the switching regulator (e.g., DC-DC converter, BUCK/BOOST/BUBO converter, etc.) with hysteretic control.

In some embodiments, the target waveform may comprise a ramp waveform. For example, the target waveform may have a first signal portion of a constant level, a second signal portion of a ramp-up level having a positive slope, and a third signal portion of a ramp-down level having a negative slope. In a preferred embodiment, the ramp-down level of the third signal portion may have a higher steepness than the ramp-up level of the second signal portion. Moreover, the frequency locking circuit may be configured to adjust one or more of a length of the constant level of the first signal portion and a steepness of the ramp-up level of the second signal portion, and a steepness of the ramp-down level of the third signal portion.

Besides, the periodic threshold signal may have the same frequency as the reference clock signal. In some embodiments, the frequency locking circuit may be configured to adjust one or more of the at least two distinct signal portions of the target waveform, such that during steady state operation of the switching regulator, the periodic threshold signal is aligned with the reference clock signal.

In some embodiments, the first control circuit may be configured to generate the first control signal for (repeatedly) turning off the power switch. In particular, the first control signal may be generated in dependence of a comparison of the level of the inductor current with a first threshold. Moreover, the second control circuit may be configured to generate the second control signal for (repeatedly) turning on the power switch. The second control signal may be generated in dependence of a comparison of the level of the inductor current with a second threshold indicated by the periodic threshold signal.

Specifically, the first control signal may comprise a sequence of first pulses, and each first pulse of the first control signal may turn off the power switch. Besides, the second control signal may comprise a sequence of second pulses, and each second pulse of the second control signal may turn on the power switch. Accordingly, the first control circuit may be configured to assert a first pulse for the first control signal when the inductor current exceeds the first threshold, and the second control circuit may be configured to assert a second pulse for the second control signal when the inductor current goes below the second threshold.

Additionally or alternatively, the first threshold may be based on a target constant peak value for the inductor current, and the second threshold may be based on a target varying valley value for the inductor current. In order to determine the second threshold properly, the frequency locking circuit may be configured to generate the periodic threshold signal based on the reference clock signal and a threshold current proportional to the target constant peak value. For example, the threshold current may be inversely proportional to the target constant peak value.

In a preferred embodiment, the frequency locking circuit may comprise a control switch which may be controlled using the reference clock signal, a control capacitor which may be arranged in parallel to the control switch and which may be charged during an off-period of the control switch to provide a capacitor voltage, a current source which may be configured to charge the control capacitor during the off-period of the control switch, and a voltage-current converter which may be configured to convert the capacitor voltage into an output control current for providing the periodic threshold signal.

Furthermore, the frequency locking circuit may be further configured to add the output control current from the voltage-current converter to the threshold current proportional to the target constant peak value to generate the periodic threshold signal.

Specifically, for aligning the periodic threshold signal with the reference clock signal, the frequency locking circuit may be further configured to adjust one or more of the at least two distinct signal portions of the target waveform by one or more of: adjusting a duty cycle of the reference clock signal, adjusting a current provided by the current source, and adjusting a capacitance of the control capacitor.

In a preferred embodiment, the frequency locking circuit may be configured to adjust one or more of a length of the constant level of the first signal portion and a steepness of the ramp-up level of the second signal portion, and a steepness of the ramp-down level of the third signal portion by controlling the current provided by the current source and/or the capacitance of the control capacitor.

In some embodiments, the first control circuit and the second control circuit may comprise a respective amplifier circuit and a respective comparator. In particular, the respective amplifier circuit may be configured to receive the output voltage and to generate the target constant peak value and the threshold current proportional to the target constant peak value. For example, the generation of the target constant peak value and/or the threshold current may be based on the output voltage and a reference voltage.

Additionally or alternatively, the respective amplifier circuit may be coupled to the frequency locking circuit for generating the periodic threshold signal.

In some embodiments, the at least one power switch may comprise a high-side power switch coupled to the input voltage and a low-side power switch coupled between the high-side power switch and a ground. In particular, the assertion of the first pulse for the first control signal (as described above) may turn off the high-side power switch but may turn on the low-side power switch. In contrast, the assertion of the second pulse for the second control signal (as described above) may turn on the high-side power switch but may turn off the low-side power switch.

In some embodiments, the switching regulator may comprise a buck converter, a boost converter and/or a buck/boost converter.

Configured as above, the proposed frequency control scheme for controlling a switching regulator (e.g., DC-DC converter, BUCK/BOOST/BUBO converter, etc.) allows to achieve better frequency accuracy and faster frequency locking speed in the switching regulator with hysteretic control, which is in particular beneficial for the use in one-phase and multi-phase converters that desire good frequency accuracy and faster frequency locking speed.

It is especially appreciated that by using the proposed frequency locking circuit in the switching regulator, the locking speed of the switching regulator can be improved, at the same time achieving enhanced frequency accuracy of the switching regulator in the steady state.

Furthermore, the proposed frequency control scheme according to the present document also provides an efficient synchronization method which requires very simple structure, consumes less current and has lower design risk than the existing solutions.

According to a further aspect, a method for controlling a switching regulator is described. The switching regulator is configured to generate an output voltage based on an input voltage using at least one power switch and an inductor. The method comprises generating a first control signal for turning off the power switch, in dependence of a level of the inductor current through the inductor. Furthermore, the method comprises generating, based on a reference clock signal, a second control signal for turning on the power switch, in dependence of the level of the inductor current through the inductor. Also, the method further comprises generating a periodic threshold signal based on the reference clock signal to control the generation of the second control signal. In particular, the periodic threshold signal may be synchronized with the reference clock signal, and each period of the periodic threshold signal may comprise a target waveform having at least two distinct signal portions.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or in some other manner.

### BRIEF DESCRIPTION OF THE DRAWINGS

The present disclosure is explained below in an exemplary manner with reference to the accompanying drawings, wherein

FIG. 1 shows an example switching regulator and/or voltage regulator 100 using hysteretic control;

FIG. 2 shows example measurement signals during operation of the switching regulator 100;

FIG. 3 shows a flow chart of an example method for controlling a switching regulator according to embodiments of the present document;

FIG. 4 shows an example switching regulator and/or voltage regulator 400 using hysteretic control with an improved frequency control scheme according to embodiments of the present document;

FIG. 5 shows an example waveform of the generated periodic threshold signal for controlling the generation of the second control signal in the switching regulator 400 according to embodiments of the present document;

FIG. 6 shows example measurement signals during operation of the switching regulator 400; and

FIG. 7A and FIG. 7B show an example control circuit of the improved frequency control scheme for controlling the switching regulator 400.

### DETAILED DESCRIPTION

As indicated above, the present document is directed to controlling a (voltage) switching regulator in a stable and accurate manner, such that a switching frequency of the switching regulator can be locked to a target value with improved locking speed (i.e., a relatively short reaction time) subject to noise present in the circuit of the switching regulator.

While certain parts of this document may make explicit reference to buck converters, it is understood that the present disclosure is not limited to buck converters and can be generally applied to a broader class of switching converters.

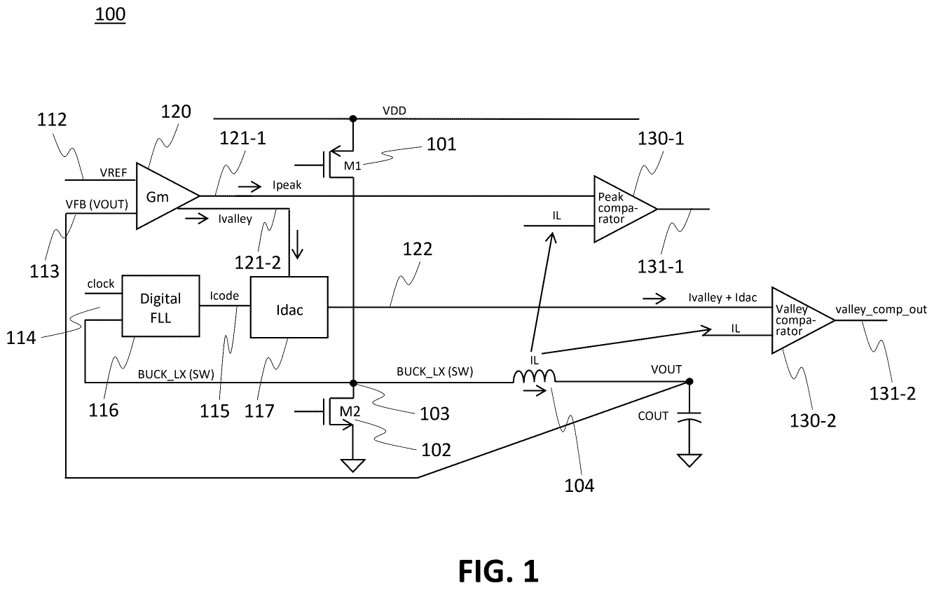

FIG. 1 shows an example switching regulator 100, in particular a buck converter using hysteretic control. The switching regulator 100 comprises a high-side power switch 101 and a low-side power switch 102, which are arranged in series between the supply or input voltage VDD and ground. The switching node LX 103 between the power switches 101, 102 is coupled to the output via an inductor 104. In general, the output voltage VOUT is fed back as a feedback voltage 113 to a control circuit of the switching regulator 100 to control the power switches 101, 102 in dependence on a reference voltage VREF 112 (for the output voltage VOUT), in dependence on the feedback voltage 113, and in dependence on a clock signal 114 (for setting the switching frequency of the switching regulator 100). In the present document, the clock signal 114 may be referred to as a reference clock signal.

Further details regarding the control circuit can be seen in FIG. 1, where the reference voltage VREF 112 is compared to the feedback voltage VFB 113 using an amplifier circuit Gm 120 to provide a control signal for controlling the power switches 101, 102 of the switching regulator 100. Specifically, a respective amplifier circuit 120 may be provided to sense the feedback voltage VFB 113 (which is proportional to VOUT) and the reference voltage VREF 112 and then to generate output current Ipeak (which may correspond to a constant target peak value of the load current IL_peak) 121-1 and Ivalley 121-2 for providing a first control signal 131-1 and a second control signal 131-2, respectively, to control the high-side power switch 101 and the low-side power switch 102. It is noted that the output current Ivalley 121-2 may be regarded as a threshold current based on which the second control signal 131-2 will be generated, and may be proportional to the output current Ipeak 121-1. In some examples, the output current Ivalley 121-2 may be inversely proportional to the output current Ipeak 121-1. Herein, the control circuit may be depicted as a first control circuit and a second control circuit having a respective amplifier circuit 120 and a respective comparator 130-1, 130-2 for controlling the power switches of the switching regulator 100.

Moreover, the switching regulator 100 in the given example further comprises a frequency locking circuit which may include a digital frequency lock loop (FLL) 116 and a current digital-to-analog converter (DAC) 117. The digital FLL 116 senses the clock signal 114 and the BUCK switching signal BUCK_LX (SW) (or a signal which is in phase with BUCK_LX (SW)) (i.e., provided at the switching node LX 103), and then generates a coding signal Icode 115 as an input signal for the current DAC 117. Subsequently, the coding signal Icode 115 and the output current Ivalley 121-2 of the respective amplifier circuit 120 may be combined (e.g., by the DAC 117) to form a threshold signal 122 (e.g., “Ivalley+Idac”) with constant current/voltage level as an output of the frequency locking circuit. Notably, the frequency of the clock signal 114 may be the desired frequency (e.g., target frequency) for the switching regulator 100 (e.g., BUCK converter). When operating at a steady-state PWM mode, the switching frequency (i.e., the frequency of the switching signal BUCK_LX) is equal (i.e., locked) to the frequency of the (reference) clock signal 114.

More specifically, a peak comparator 130-1 may compare a signal proportional to (the peak value of) the inductor current IL (IL_peak) to the output current Ipeak 121-1 and generate an output control signal peak_comp_out 131-1, which may be used for controlling the power switches 101, 102. The control signal peak_comp_out 131-1 may be referred to herein as the first control signal. Furthermore, a valley comparator 130-2 may compare a signal proportional to (the valley value of) the inductor current IL the (IL_valley) to the threshold signal 122 (i.e., “Ivalley+Idac”) and generate another output control signal valley_comp_out 131-2 for controlling the power switches 101, 102. The control signal valley_comp_out 131-2 may be referred to herein as the second control signal.

According to the given example, the first control signal 131-1 may turn off the high-side power switch 101 (and may also turn on the low-side power switch 102) depending on a level of the inductor current IL through the inductor 104, while the second control signal 131-2 may turn on the high-side power switch 101 (and may also turn off the low-side power switch 102) depending on the level of the inductor current IL through the inductor 104.

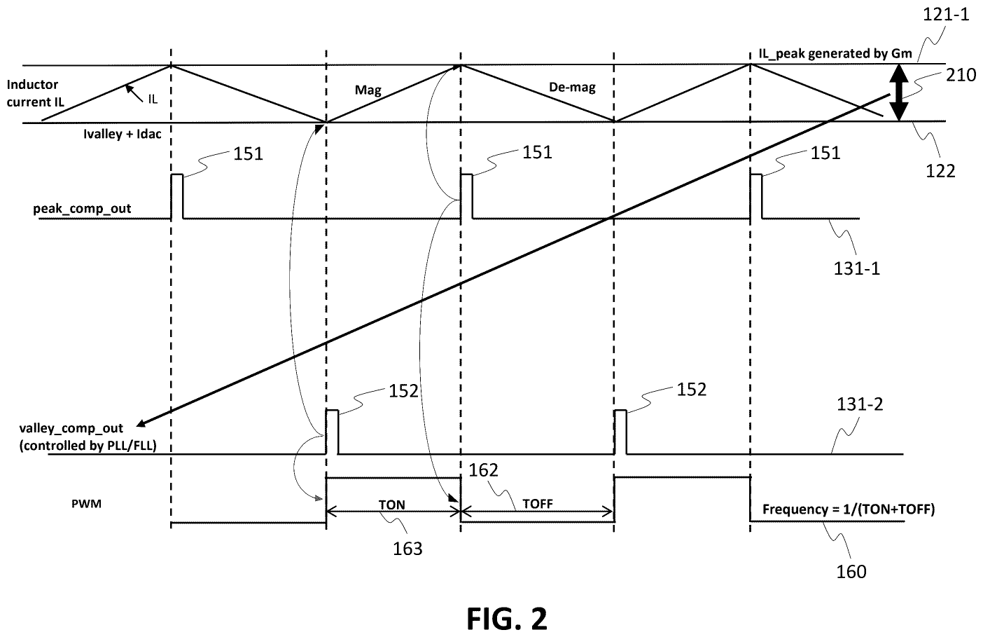

FIG. 2 schematically shows examples of the key signals in an example BUCK converter (e.g., regulator 100) using hysteretic control with a frequency locking circuit (including the digital FLL 116). As illustrated in FIG. 2, when the inductor current IL goes above Ipeak 121-1 (generated from the amplifier circuit 120), the peak comparator 130-1 asserts (i.e., the first control signal peak_comp_out 131-1 goes high, as depicted by a first control pulse 151), the inductor current IL starts to ramp down (i.e., enter the de-mag phase). When the inductor current IL goes below the threshold signal 122 (e.g., “Ivalley+Idac”) (generated from the digital FLL 116 and DAC 117), the valley comparator 130-2 asserts (i.e., the second control signal valley_comp_out 131-2 goes high, as depicted by a second control pulse 152), the inductor current IL starts to ramp up (i.e., enters the mag phase). Therefore, the inductor current IL may vary between its peak value IL_peak (which may be proportional to Ipeak 121-1) and its valley value IL_valley (which may by proportional to “Ivalley+Idac” 122).

Accordingly, a pulse width modulation (PWM) signal 160 is generated based on the control signals peak_comp_out 131-1 and valley_comp_out 131-2 and is used to control the power switches 101, 102. When the first control signal peak_comp_out 131-1 goes high (as indicated by 151), the PWM signal 160 goes low (as indicated by 162), where power switch 101 is turned OFF and power switch 102 is turned ON. On the other hand, when the second control signal valley_comp_out 131-2 goes high (as indicated by 152), the PWM signal 160 goes high (as indicated by 163), where power switch 101 is turned ON and power switch 102 is turned OFF. It is noted that the difference between the peak value IL_peak and the valley value IL_valley of the inductor current is called “hysteresis window” (as indicated by 210), which may be adjusted by the digital FLL 116 and the current DAC 117 of the frequency locking circuit. It is further appreciated that the PWM signal 160 is synchronized with the BUCK_LX switching signal, for example in that they may be in phase and may have the same frequency.

In other words, the first control signal peak_comp_out 131-1 may be generated such that the first control pulse 151 is generated, each time the inductor current IL reaches a pre-determined peak-current (e.g., Ipeak) 121-1 which is set by the (respective) amplifier circuit 120. The first control signal peak_comp_out 131-1 may be used to trigger the turn-off of the high-side power switch 101 of the switching regulator 100. On the other hand, the second control signal valley_comp_out 131-2, in particular, the second control pulse 152 of the second control signal 131-2 may be used to trigger the turn-on of the high-side power switch 101. Hence, the second control signal 131-2 may be used to set the total length of a cycle period of the generated PWM signal, and the first control signal peak_comp_out 131-1 may be used to set the duration of the duty cycle (which may correspond to the ON period of the PWM signal as indicated by 163) within the cycle period.

As shown in FIG. 2, the PWM signal 160 for controlling the power switches 101, 102 includes an on-period 163, during which the high-side power switch 101 is turned on (and the low-side power switch 102 is turned off), that starts with the second control pulse 152 of the second control signal valley_comp_out 131-2 and ends with the first control pulse 151 of the first control signal peak_comp_out 131-1. Furthermore, the subsequent off-period 162, during which the high-side power switch 101 is turned off (and the low-side power switch 102 is turned on), starts with the first control pulse 151 of the first control signal 131-1 and ends with the subsequent second control pulse 152 of the second control signal 131-2.

When the switching frequency (i.e., the frequency of the switching signal BUCK_LX at node 103) is not close to the frequency of clock signal 114, the digital FLL 116 and the current DAC 117 of the frequency clocking circuit may adjust the “hysteresis window” 210, in particular the level of the threshold signal 122 (e.g., “Ivalley+Idac”), until the switching frequency is equal (locked) to the frequency of clock signal 114. Preferably, the pre-determined peak-current (e.g., Ipeak) 121-1 may remain constant to limit the load current to a constant target peak value (e.g., IL_peak).

As mentioned above, the performance of hysteretic control implemented in this way may be influenced by the noise present in the circuit of the switching regulator. Besides, it may take a relatively long time until the switching frequency is locked to the target frequency.

In the present document, an improved control scheme for controlling a switching regulator is described, which can achieve better frequency accuracy and faster frequency locking speed in the switching regulator (e.g., DC-DC converter, BUCK/BOOST/BUBO converter, etc.) with hysteretic control. In particular, it can be used in one-phase and multi-phase converters, especially converters that desire good frequency accuracy and faster frequency locking speed. Specifically, the improved control scheme comprises circuitry to be implemented in the frequency locking circuit to generate a periodic threshold signal for controlling the generation of the second control signal 131-2. The periodic threshold signal may be synchronized with the (reference) clock signal 114, and each period of the periodic threshold signal may comprise a target waveform having at least two distinct signal portions.

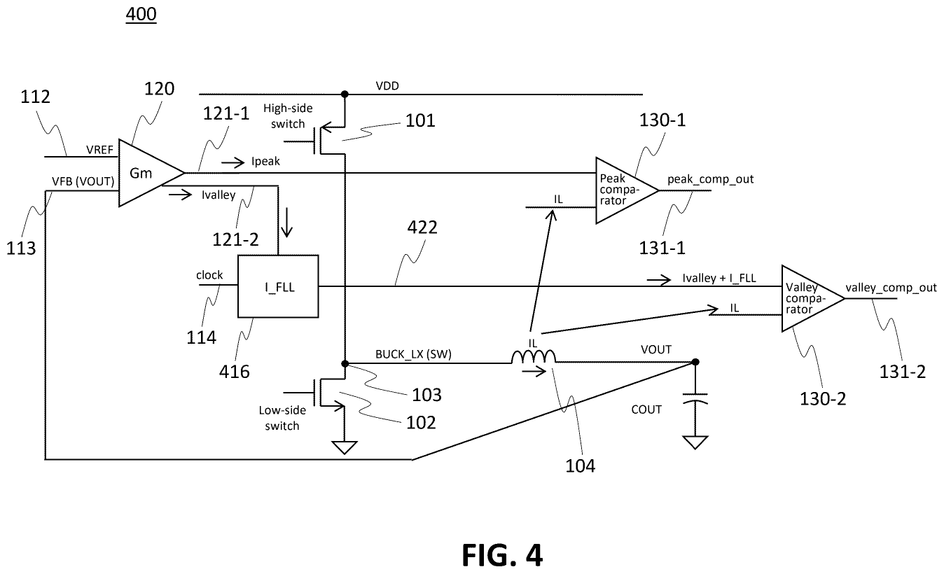

FIG. 4 shows an example switching regulator 400, in particular a buck converter using hysteretic control with an improved frequency control scheme according to embodiments of the present document. Compared to the method of controlling frequency as illustrated in the switching regulator 100 of FIG. 1, the frequency control scheme for the switching regulator 400 as shown in FIG. 4 replaces the “hysteresis window” 210 of FIG. 2 (used as a basis for controlling the switching frequency of the regulator 100 in FIG. 1) with a periodic signal serving as a threshold to control the generation of the second control signal 131-2, namely, to provide proper controlling/adjusting of the valley value of the inductor current IL, so as to lock the switching frequency to the target (clock) frequency accordingly. In both FIG. 1 and FIG. 4, identical elements are provided with identical reference signs, so that a repeated description of the elements is omitted unless necessary.

As illustrated in FIG. 4, the frequency locking circuit of the switching regulator 400 comprises a “I_FLL” block 416 that replaces the digital FLL 116 and the current DAC 117 in the regulator 100. The clock signal 114 and the output current Ivalley from the respective amplifier circuit 120 are sensed by the I_FLL block 416 which then generates the above-mentioned periodic threshold signal (“Ivalley+I_FLL”) 422 for controlling generation of the second control signal 131-2. Similar to the switching regulator 100 of FIG. 1, in the steady-state PWM mode, the switching frequency of the regulator 400 (e.g., the frequency of the BUCK_LX signal) is equal (locked) to the frequency of the clock signal 114. It is further noted that the generation of the first control signal 131-1 for the regulator 400 may be the same or similar to that for the above described regulator 100.

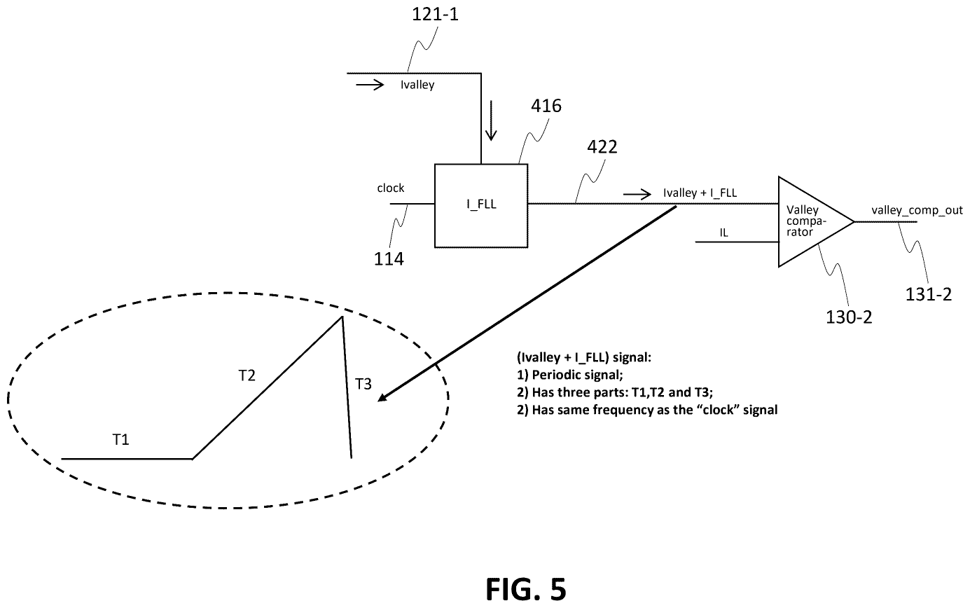

FIG. 5 schematically illustrates an example waveform of the generated periodic threshold signal (“Ivalley+I_FLL”) 422 (output by the I_FLL block 416) for controlling the generation of the second control signal 131-2. Notably, the frequency (or period) of this periodic threshold signal 422 may be the same as the frequency (or period) of clock signal 114.

Moreover, in each period of the signal 422, it may contain three distinct portions (parts, segments), namely, a first portion T1, a second portion T2 and a third portion T3, as illustrated by the example waveform of FIG. 5. In this example, T1 is a constant value, while T2 and T3 are not constant and have (respective) slopes.

It is noted that the example waveform for the periodic threshold signal 422 as shown in FIG. 5 merely depicts a possible embodiment for generating the periodic threshold signal 422, which shall not be regarded as limiting the scope of implementing the frequency control/locking scheme according to the present document. For example, in each period, the generated periodic threshold signal 422 may have only two distinct portions, or the generated periodic threshold signal 422 may have more than three distinct portions, with slopes other than those of T2/T3.

Importantly, the periodic threshold signal 422 comprises at least a portion with positive slope (ramp-up), possibly following after a portion with (substantially) zero slope. It is also understood that at the end of each period, the periodic threshold signal 422 needs to return to the signal value at the start of each period, implying a portion with negative (and potentially steep) slope. For the case of a portion with positive slope (ramp-up) following after a portion with (substantially) zero slope, respective durations of the portions may be design parameters of the system.

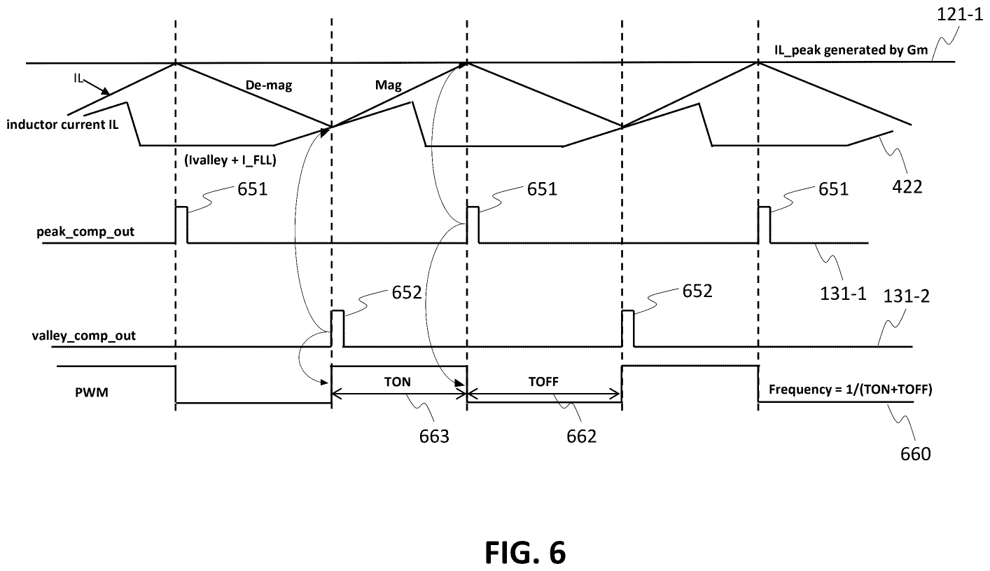

FIG. 6 schematically shows the key (main control) signals in an example BUCK converter (e.g., regulator 400) using the improved frequency control/locking scheme (including the I_FLL block 416) according to embodiments of the present document. As illustrated in FIG. 6, when the inductor current IL goes above the Ipeak 121-1 (generated from the amplifier circuit 120), the peak comparator 130-1 asserts (i.e., the first control signal peak_comp_out 131-1 goes high, as depicted by a first control pulse 651), the inductor current IL starts to ramp down (e.g., enters the de-mag phase). When the inductor current IL goes below the periodic threshold signal 422 (e.g., “Ivalley+I_FLL”) (generated from the I_FLL block 416), the valley comparator 130-2 asserts (i.e., the second control signal valley_comp_out 131-2 goes high, as depicted by a second control pulse 652), the inductor current IL starts to ramp up (e.g., enters the mag phase). Similar to the regulator 100, the inductor current IL in the case of regulator 400 may vary between its peak value IL_peak (which corresponds to the Ipeak 121-1) and its valley value IL_valley (which corresponds to the periodic threshold signal “Ivalley+I_FLL” 422). However, different than the threshold signal 122 of the regulator 100 which has a constant level in the steady state, the periodic threshold signal 422 according to the regulator 400 is a periodic signal with levels changing with time (as illustrated by the above described waveform in FIG. 5).

Accordingly, a PWM signal 660 is generated based on the control signals peak_comp_out 131-1 and valley_comp_out 131-2 and is used to control the power switches 101, 102 of the regulator 400. When the first control signal peak_comp_out 131-1 goes high (as indicated by 651), the PWM signal 660 goes low (as indicated by 662), where power switch 101 is turned OFF and power switch 102 is turned ON. On the other hand, when the second control signal valley_comp_out 131-2 goes high (as indicated by 652), the PWM signal 660 goes high (as indicated by 663), where power switch 101 is turned ON and power switch 102 is turned OFF. Similar to the regulator 100, the PWM signal 660 generated for the regulator 400 may be synchronized with the BUCK_LX switching signal and they may be in phase and may have the same frequency (e.g., corresponding to the clock frequency).

It is further appreciated that the resulting signal evolution of the switching regulator 400 (e.g., the first and second control signals, the PWM signal, etc., except for the periodic threshold signal 422) as shown in FIG. 6 may be similar to that of the switching regulator 100 as shown in FIG. 2.

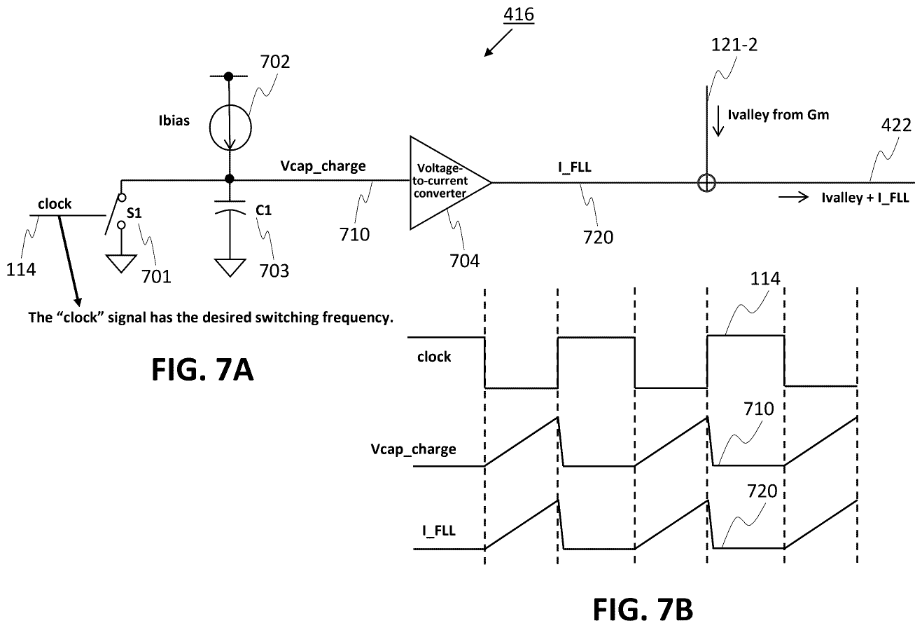

FIG. 7A schematically illustrates an example implementation of the frequency locking circuit 416 (i.e., the “I_FLL” block as shown in FIG. 4 and FIG. 5) for generating the periodic threshold signal 422 according to embodiments of the present document. Specifically as shown in FIG. 7A, the frequency locking circuit 416 to be implemented in the regulator 400 comprises a control switch S1 701 which is controlled using the reference clock signal 114, a control capacitor C1 703 which is arranged in parallel to the control switch 701 and which is charged during an off-period of the control switch 701 to provide a capacitor voltage Vcap_charge 710, a current source Ibias 702 configured to charge the control capacitor 703 during the off-period of the control switch 701, and a voltage-current converter 704 configured to convert the capacitor voltage Vcap_charge 710 into an output control current I_FLL 720 for providing the periodic threshold signal 422. Besides, the frequency locking circuit 416 is further configured to add the output control current 720 from the voltage-current converter 704 to the threshold current Ivalley 121-2 (which, as indicated above, may be proportional to the target constant peak value Ipeak 121-1) to generate the periodic threshold signal 422.

The operating principle of the frequency locking circuit 416 according to FIG. 7A is described as below. In this example, the capacitor C1 703 is charged periodically by the bias current Ibias 702. The voltage across the control capacitor C1 is Vcap_charge 710. A switch S1 701 is tied between the Vcap_charge and the ground (0V) and is controlled by the clock signal 114. When the clock signal 114 goes “HIGH”, S1 701 is turned on and the capacitor C1 703 is discharged (i.e., the current from Ibias 702 flows through S1 701), and Vcap_charge 710 is pulled down to 0V with very large slope and then stays at 0V. On the other hand, when the clock signal 114 goes “LOW”, S1 701 is turned off and the capacitor C1 703 is charged by Ibias 702 and the capacitor voltage Vcap_charge 710 ramps up (where the ramp-up slope may be controlled by the value of Ibias and C1). The capacitor voltage Vcap_charge 710 is then sensed by the voltage-to-current converter 704 which converts the capacitor voltage 710 of C1 to a control current signal I_FLL 720. Accordingly, the capacitor voltage Vcap_charge 710 and the current signal I_FLL 720 may have the same frequency and shape (with the difference that Vcap_charge is a voltage signal and I_FLL is a current signal). The current signal I_FLL 720 is then combined with the current Ivalley from the respective amplifier circuit Gm 120, which is then sent out as the output of the frequency locking circuit (“I_FLL”) 416. The corresponding signals for the clock 114, the capacitor voltage Vcap_charge 710 and the current signal I_FLL 720 are shown in FIG. 7B as an example for the frequency locking circuit 416.

It is appreciated that the signal waveforms shown in FIG. 7B are merely for illustrative purpose and shall not be regarded as limiting the scope of implementing the frequency control/locking scheme according to the present document. Especially, the waveforms of the capacitor voltage Vcap_charge 710 and the current signal I_FLL 720 may be determined or adjusted by the parameters of the individual elements of the frequency locking circuit 416, such as the current source 702, the control capacitor 703, the voltage-to current converter 704, and so on.

Accordingly, the proposed frequency control/locking scheme according to the present document allows for controlling a (voltage) switching regulator in a stable and accurate manner, such that switching frequency of the switching regulator can be locked to a target value with an improved locking speed (i.e., a relatively low reaction time) subject to noise present in the circuit of the switching regulator. Thereby, better frequency accuracy and faster frequency locking speed in a switching regulator (e.g., DC-DC converter, BUCK/BOOST/BUBO converter, etc.) with hysteretic control can be achieved.

Furthermore, such a synchronization method according to the present document requires very simple structure which consumes less current and has lower design risk than the existing solutions.

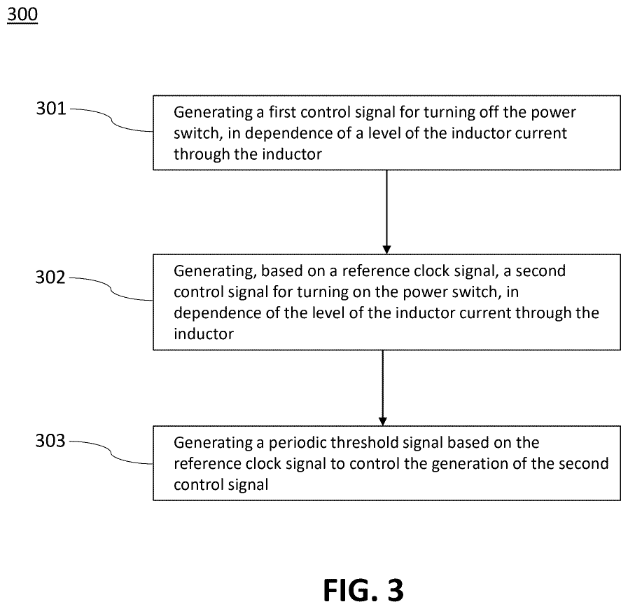

FIG. 3 shows a flow chart of an example method 300 for controlling a switching regulator (e.g., the regulator 400) according to embodiments of the present document, wherein the switching regulator 400 is configured to generate an output voltage VOUT based on an input voltage VDD using at least one power switch 101 and an inductor 104. The method 300 comprises generating 301 a first control signal 131-1 for turning off the power switch 101, in dependence of a level of the inductor current through the inductor 104. The method 300 also comprises generating 302, based on a reference clock signal 114, a second control signal 131-2 for turning on the power switch 101, in dependence of the level of the inductor current through the inductor 104.

Furthermore, the method 300 comprises generating 303 a periodic threshold signal 422 based on the reference clock signal 114 to control the generation of the second control signal 131-2. In particular, the periodic threshold signal 422 may be synchronized with the reference clock signal 114. Besides, each period of the periodic threshold signal 422 may comprise a target waveform having at least two distinct signal portions (e.g., T1, T2, T3 as illustrated in FIG. 5).

As outlined in the present document, the periodic threshold signal 422 may be generated using a frequency locking circuit as described above, for example, using the I_FLL block 416 as shown in FIGS. 4, 7A and 7B.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A switching regulator configured to generate an output voltage based on an input voltage using at least one power switch and an inductor, the switching regulator comprising:
a first control circuit configured to generate a first control signal for turning off the power switch, in dependence of a level of the inductor current through the inductor;
a second control circuit configured to generate, based on a reference clock signal for setting a switching frequency of the switching regulator, a second control signal for turning on the power switch, in dependence of the level of the inductor current through the inductor; and
a frequency locking circuit coupled to the second control circuit and configured to generate a periodic threshold signal based on the reference clock signal to control the generation of the second control signal, wherein the periodic threshold signal is synchronized with the reference clock signal, and each period of the periodic threshold signal comprises a target waveform having at least two distinct signal portions.

2. The switching regulator of claim 1, wherein the target waveform comprises a ramp waveform, the target waveform having a first signal portion of a constant level, a second signal portion of a ramp-up level having a positive slope, and a third signal portion of a ramp-down level having a negative slope.

3. The switching regulator of claim 1, wherein the periodic threshold signal has a same frequency as the reference clock signal.

4. The switching regulator of claim 1, wherein the frequency locking circuit is configured to adjust one or more of the at least two distinct signal portions of the target waveform, such that during steady state operation of the switching regulator, the periodic threshold signal is aligned with the reference clock signal.

5. The switching regulator of claim 2, wherein the ramp-down level of the third signal portion has a higher steepness than the ramp-up level of the second signal portion.

6. The switching regulator of claim 2, wherein the frequency locking circuit is configured to adjust one or more of a length of the constant level of the first signal portion and a steepness of the ramp-up level of the second signal portion, and a steepness of the ramp-down level of the third signal portion.

7. The switching regulator of claim 1, wherein the first control circuit is configured to generate the first control signal for turning off the power switch, in dependence of a comparison of the level of the inductor current with a first threshold.

8. The switching regulator of claim 7, wherein the second control circuit is configured to generate the second control signal for turning on the power switch, in dependence of a comparison of the level of the inductor current with a second threshold indicated by the periodic threshold signal.

9. The switching regulator of claim 8, wherein:
the first control signal comprises a sequence of first pulses, and each first pulse of the first control signal turns off the power switch;
the second control signal comprises a sequence of second pulses, and each second pulse of the second control signal turns on the power switch;
the first control circuit is configured to assert a first pulse for the first control signal when the inductor current exceeds the first threshold; and
the second control circuit is configured to assert a second pulse for the second control signal when the inductor current goes below the second threshold.

10. The switching regulator of claim 8, wherein the first threshold is based on a target constant peak value for the inductor current, and wherein the second threshold is based on a target varying valley value for the inductor current.

11. The switching regulator of claim 10, wherein the frequency locking circuit is configured to generate the periodic threshold signal based on the reference clock signal and a threshold current proportional to the target constant peak value.

12. The switching regulator of claim 11, wherein the frequency locking circuit comprises
a control switch which is controlled using the reference clock signal;
a control capacitor which is arranged in parallel to the control switch and which is charged during an off-period of the control switch to provide a capacitor voltage;
a current source configured to charge the control capacitor during the off-period of the control switch; and
a voltage-current converter configured to convert the capacitor voltage into an output control current for providing the periodic threshold signal.

13. The switching regulator of claim 12, wherein the frequency locking circuit is further configured to add the output control current from the voltage-current converter to the threshold current proportional to the target constant peak value to generate the periodic threshold signal.

14. The switching regulator of claim 12, wherein, for aligning the periodic threshold signal with the reference clock signal, the frequency locking circuit is further configured to adjust one or more of the at least two distinct signal portions of the target waveform by one or more of:
adjusting a duty cycle of the reference clock signal,
adjusting a current provided by the current source, and
adjusting a capacitance of the control capacitor.

15. The switching regulator of claim 14, wherein the frequency locking circuit is configured to adjust one or more of a length of the constant level of the first signal portion and a steepness of the ramp-up level of the second signal portion, and a steepness of the ramp-down level of the third signal portion by controlling the current provided by the current source and/or the capacitance of the control capacitor.

16. The switching regulator of claim 11, wherein the first control circuit and the second control circuit comprise a respective amplifier circuit and a respective comparator, wherein the respective amplifier circuit is configured to receive the output voltage and to generate the target constant peak value and the threshold current proportional to the target constant peak value, based on the output voltage and a reference voltage.

17. The switching regulator of claim 16, wherein the respective amplifier circuit is coupled to the frequency locking circuit for generating the periodic threshold signal.

18. The switching regulator of claim 9, wherein the at least one power switch comprises a high-side power switch coupled to the input voltage and a low-side power switch coupled between the high-side power switch and a ground, wherein the assertion of the first pulse for the first control signal turns off the high-side power switch but turns on the low-side power switch, while the assertion of the second pulse for the second control signal turns on the high-side power switch but turns off the low-side power switch.

19. The switching regulator of claim 1, wherein the switching regulator comprises a buck converter, a boost converter and/or a buck/boost converter.

20. A method for controlling a switching regulator which is configured to generate an output voltage based on an input voltage using at least one power switch and an inductor, wherein the method comprises:
generating a first control signal for turning off the power switch, in dependence of a level of the inductor current through the inductor;
generating, based on a reference clock signal, a second control signal for turning on the power switch, in dependence of the level of the inductor current through the inductor; and
generating a periodic threshold signal based on the reference clock signal to control the generation of the second control signal, wherein the periodic threshold signal is synchronized with the reference clock signal, and each period of the periodic threshold signal comprises a target waveform having at least two distinct signal portions.
